(19) United States
(12) Patent Application Publication
(10) Pub. No.: US 2013/0311141 A1
(43) Pub. Date: Nov. 21, 2013

(54) SIGNAL DENOISING METHODS FOR A CHARGE DETECTION FREQUENCY-SCAN/VOLTAGE-SCAN QUADRUPOLE/LINEAR/RECTILINEAR ION TRAP MASS SPECTROMETER

(71) Applicant: National Dong Hwa University, Hualien (TW)

(72) Inventors: Wen-Ping Peng, New Taipei City (TW); Szu-Wei Chou, Hualien County (TW); Hsin-Min Shen, Taipei City (TW); Kou-Hwa Chang, Taichung City (TW)

(73) Assignee: National Dong Hwa University, Hualien (TW)

(21) Appl. No.: 13/897,463

(22) Filed: May 20, 2013

Related U.S. Application Data
(60) Provisional application No. 61/648,630, filed on May 18, 2012.

(51) Int. Cl. H01J 49/02

(52) U.S. Cl. CPC H01J 49/022
USPC 702/191

(57) ABSTRACT

A signal denoising method for a frequency-scan ion trap mass spectrometer includes reading a signal raw data array observed in the spectrometer. The signal raw data array is processed by Boxcar averaging method to obtain a first signal array. Then the first signal array is processed by a harmonic interference cancellation method to obtain a second data array. Next the second signal array is processed by a radio frequency interference reduction method and a third signal array without the background induced from driving voltage of ion trap is reconstructed according to the second signal array.

### CROSS REFERENCE TO RELATED APPLICATIONS

This application claims the benefit of U.S. Provisional Application Ser. No. 61/648,630 entitled “Wavelet-based Method for Time-Domain Noise Analysis and Reduction in a Frequency-Scan Ion Trap Mass Spectrometer”, filed May 18, 2012, and included herein by reference in its entirety for all intents and purposes.

### BACKGROUND OF THE INVENTION

1. Field of the Invention

The present invention is related to a signal denoising method, and more particularly, to a signal denoising method based on a wavelet-based method for time-domain noise reduction of a charge detection frequency-scan/voltage-scan quadrupole/linear/rectilinear ion trap mass spectrometer.

2. Description of the Prior Art

Denoising is an important data processing method in improving the signal-to-noise ratio (S/N) of a spectrum. Most denoising approaches currently adopted in mass spectrometry are to smooth spectra or average the noises in mass-to-charge (m/Ze) domain.¹⁻⁸ Barclay et al. compared various methods for smoothing in processing spectra, including orthogonal transform (Fourier transform), windowed smoothing algorithms (Savitzky-Golay or Kalman averaging) and discrete wavelet decomposition or discrete wavelet packet decomposition.⁹ They found that the wavelet-based methods result in minimal distortion of original data. Li et al. later showed that by proper selection of wavelet functions and decomposition levels, the noise embedded in the mass spectrometry data can be substantially removed.⁶ However; these denoising approaches did not characterize the modules of noise features, and unavoidably lead to distortion of original signals when they are transformed from the time domain to the m/Ze domain. Hence, there is a desire to develop methods to remove the noises without domain transformation.¹⁰ Xu proposed to perform distortion-free harmonic interference noise cancellation in the time domain with a wavelet-based method and demonstrated its feasibility by using a simulated piecewise smooth signal and a real and irregularly pulsating signal.^{11,12} The method provides a useful alternative to improve S/N ratios.

For a signal observed in a mass spectrum, it is typically composed of three parts:¹¹⁻¹³

S( [symbol] )=Sₓ( [symbol] )+Nₕ( [symbol] )+N_{w}( [symbol] ) (1)

where S( [symbol] ) is the observed signal, [symbol] is the time, Sₓ( [symbol] ) is the original signal without noise interference, Nₕ( [symbol] ) is the harmonic interference induced by the AC power source, and N_{W}( [symbol] ) is the zero-mean Gaussian white noise. The last term is encountered whenever electrons cross the pn interfaces in electronic circuits and can be reduced by using a Boxcar averaging method or low pass filters.¹⁴ Many researches use notch filters and comb-shaped filters¹⁵⁻²¹ to remove Nₕ( [symbol] ) but they cause distortion of original signals.^{11,12} Xu has shown that it is possible to remove Nₕ( [symbol] ) by a harmonic interference cancellation algorithm, which cancels the Nₕ( [symbol] ) completely, reduces N_{w}( [symbol] ) and retains the signal without distortion.¹¹ In this study, we apply the algorithm to remove the time-domain electronic noises in the ion signals acquired with a home-built laser desorption/ionization charge detection ion trap mass spectrometer (LDCD-ITMS).²²⁻²⁷

In analyzing the mass spectra, we notice that Eq. (1) is not enough to describe the signal components because the applied radio-frequency (RF) driving voltage for the ion trap is high and will inevitably interfere (N_{RF}( [symbol] )) with the signal (S( [symbol] )). We know of no methods reported to remove the N_{RF}( [symbol] ) due to coupling of Sₓ( [symbol] ) with the RF driving voltage. Here, we present an orthogonal wavelet packet decomposition (OWPD) method to achieve the task and show that N_{RF}( [symbol] ) is the dominant noise in the mass spectra obtained with LDCD-ITMS.²²⁻²⁹ The removal of N_{RF}( [symbol] ) is critically important in our application of the CD-ITMS technique to measure the masses of nanometer-sized particles, of which higher RF frequencies are required for the trapping. Using trapping frequencies higher than 1 kHz gives rise to distinct noises superimposed on the signals, as clearly observed in detection of 0.7 μm polystyrene spheres. Our denoising method successfully removes the noises without any distortion and hence improves the S/N ratios.

With the denoising program developed in this work, we are able to reduce substantially the levels of Nₕ( [symbol] ) and N_{RF}( [symbol] ), which makes the further reduction of white noise of the charge detector possible. Currently, the mass resolution of our frequency-scan ion trap mass spectrometer is −12. The reduction of electronic white noise will not only improve the resolution of the mass spectrometer but also enhance its detection sensitivity for detecting nanoparticles.

### REFERENCES

(1) Cappadona, S.; Levander, F.; Jansson, M.; James, P.; Cerutti, S.; Pattini, L. Anal. Chem. 2008, 80, 4960-4968.
(2) Morris, J. S.; Coombes, K. R.; Koomen, J.; Baggerly, K. A.; Kobayashi, R. Bioinformatics 2005, 21, 1764-1775.
(3) Coombes, K. R.; Tsavachidis, S.; Morris, J. S.; Baggerly, K. A.; Hung, M. C.; Kuerer, H. M. Proteomics 2005, 5, 4107-4117.
(4) Wang, P. H.; Yang, P. Y.; Arthur, J.; Yang, J. Y. H. Bioinformatics 2010, 26, 2242-2249.
(5) Du, P.; Kibbe, W. A.; Lin, S. M. Bioinformatics 2006, 22, 2059-2065.
(6) Li, X. L.; Li, J.; Yao, X. Comput. Biol. Med. 2007, 37, 509-516.
(7) Andreev, V. P.; Rejtar, T.; Chen, H. S.; Moskovets, E. V.; Ivanov, A. R.; Karger, B. L. Anal. Chem. 2003, 75, 6314-6326.
(8) Erickson, C. L.; Lysaght, M. J.; Callis, J. B. Anal. Chem. 1992, 64, 1155A-1163A.
(9) Barclay, V. J.; Bonner, R. F.; Hamilton, I. P. Anal. Chem. 1997, 69, 78-90.
(10) Oppenheim, A. V.; Willsky, A. S.; Young, I. T. Signals and systems; Prentice-Hall, 1983.
(11) Xu, L. J. Ieee T Signal Proces 2005, 53, 222-230.
(12) Xu, L. J.; Yan, Y. Meas Sci Technol 2004, 15, 1779-1786.
(13) Liguori, C.; Paolillo, A.; Pignotti, A. Ieee T Instrum Meas 2006, 55, 562-569.
(14) Douglas A. Skoog, F. J. H., Timothy A. Nieman. Principles of Instrumental Analysis; Thomson Learning, 1998.
(15) Delmas, J. P. Signal Processing, IEEE Transactions on 1995, 43, 2323-2331.
(16) Fainzilberg, L. S.; Glushauskene, G. A. J Automat Inf Sci 2009, 41, 55-70.
(17) Tsai, C. D.; Chiou, D. C.; Lin, Y. D.; Chan, H. L.; Wu, C. P. J. Chin. Inst. Eng. 1998, 21, 605-610.
(18) Zhang, S.; Li, D.; Sun, J. Key Eng Mat 2005, 295-296, 673-678.
(19) Chen, B.-S.; Yang, T.-Y.; Lin, B.-H. Signal Processing 1992, 27, 161-176.
(20) Glover, J., Jr. Acoustics, Speech and Signal Processing, IEEE Transactions on 1977, 25, 484-491.
(21) Pilt, K.; Meigas, K.; Ferenets, R.; Kaik, J. Conf Proc IEEE Eng Med Biol Soc 2009, 2009, 5693-6.
(22) Nie, Z. X.; Lin, C. W.; Peng, W. P.; Lee, Y. T.; Chang, H. C. J. Chin. Chem. Soc. 2006, 53, 47-52.
(23) Peng, W. P.; Lin, H. C.; Chu, M. L.; Chang, H. C.; Lin, N. H.; Yu, A. L.; Chen, C. H. Anal. Chem. 2008, 80, 2524-2530.
(24) Peng, W. P.; Lin, H. C.; Lin, H. H.; Chu, M.; Yu, A. L.; Chang, H. C.; Chen, C. H. Angew Chem Int Edit 2007, 46, 3865-3869.
(25) Peng, W. P.; Yang, Y. C.; Kang, M. W.; Tzeng, Y. K.; Nie, Z. X.; Chang, H. C.; Chang, W.; Chen, C. H. Angew Chem Int Edit 2006, 45, 1423-1426.
(26) Xiong, C.; Xu, G.; Zhou, X.; Wang, J.; Tang, Y.; Chen, R.; Peng, W. P.; Chang, H. C.; Nie, Z. Analyst 2012, 137, 1199-204.
(27) Xiong, C. Q.; Zhou, X. Y.; Chen, R.; Zhang, Y. M.; Peng, W. P.; Nie, Z. X.; Chang, H. C.; Liu, H. W.; Chen, Y. Anal. Chem. 2011, 83, 5400-5406.
(28) Peng, W. P.; Yang, Y. C.; Lin, C. W.; Chang, H. C. Anal. Chem. 2005, 77, 7084-9.
(29) Lin, H. C.; Lin, H. H.; Kao, C. Y.; Yu, A. L.; Peng, W. P.; Chen, C. H. Angew Chem Int Edit 2010, 49, 3460-3464.
(30) Mallat, S. A Wavelet Tour of Signal Processing, 3rd ed., Third Edition: The Sparse Way; Academic Press, 2008.
(31) Taylor, J. R. An introduction to error analysis: the study of uncertainties in physical measurements; University Science Books: Mill Valley, Calif., 1982.
(32) Nie, Z.; Cui, F.; Chu, M.; Chen, C. H.; Chang, H. C.; Cai, Y. Int. J. Mass spectrom. 2008, 270, 8-15.
(33) See Amptek A250CF in http://www.amptek.com
(34) Marshall, A. G.; Hendrickson, C. L.; Jackson, G. S. Mass Spectrom. Rev. 1998, 17, 1-35.
(35) Hu, Q. Z.; Noll, R. J.; Li, H. Y.; Makarov, A.; Hardman, M.; Cooks, R. G. J. Mass Spectrom. 2005, 40, 430-443.

### SUMMARY OF THE INVENTION

An embodiment of the present invention discloses a signal denoising method for a charge detection frequency-scan ion trap mass spectrometer and a charge detection voltage-scan rectilinear/linear ion trap mass spectrometer. The method comprises reading a signal raw data array observed in the spectrometer. Process the signal raw data array by Boxcar averaging method to obtain a first signal array. Process the first signal array by a harmonic interference cancellation method to obtain a second data array. Process the second signal array by a radio frequency (RF) interference reduction method and reconstruct a third signal array without the background induced from driving voltage of ion trap according to the second signal array.

Another embodiment of the present invention discloses an RF interference cancellation method. The method comprises reading a raw signal in time domain and reading hopping frequencies. Predict ideal waveform of frequency scanned by the hopping frequencies. Calculate phase differences between the raw signal and the ideal waveform at each hopping frequency. Calculate true phases at each sampling points of the raw signal. Input a number i of phases N for resampling, beginning with i=0. Resample the raw signal at phase[i]=2*pi*i/N, wherein pi is the ratio of a circle's circumference to its diameter. Determine the baseline[i] of resampled signals by using wavelet decomposition and reconstruction. Check if i is equal to N; if not, i=i+1 and redo previous two steps; if so, continue. Find an amplitude A by fitting baseline[i] with a function A*sin(phase [i]). Construct background at each sampling points by a function A*sin(true phases). Subtract the background from the raw signal and output signal without the background induced from driving voltage of ion trap.

Another embodiment of the present invention discloses an RF interference cancellation method for a voltage-scan ion trap mass spectrometer. The method comprises reading a signal S in time domain and reading an input driving frequency f. Resample the signal S with a sampling rate f*2̂J, wherein J is a deepest decomposition level. Decompose the signal S by wavelet packet decomposition to level J, wherein the wavelet packet decomposition coefficients are D₀, D₁ . . . D_{2J-1}. Set a number i=1. Fit D with a liner function and subtracting the linear function from Dᵢ. Set i=i+1. Checking if i is equal to 2J−1; if not, redo previous two steps; if so, continue. Get a denoised signal from reconstruction of the wavelet packet decomposition coefficients; and write the denoised signal.

Another embodiment of the present invention discloses an RF interference cancellation method for a voltage-scan ion trap mass spectrometer. The method comprises combining a charge detector and rectilinear/linear ion trap for detecting high mass ions. A waveguide cavity surrounding the rectilinear/linear ion trap is provided to reduce induced radio frequency interference from the rectilinear/linear ion trap. An orthogonal wavelet packet decomposition (OWPD) based algorithm is used to remove radio frequency interference substantially without any signal distortion. The method further comprises reading a signal S in time domain and reading an input driving frequency f. Resample the signal S with a sampling rate f*2̂J, wherein J is a deepest decomposition level. Decompose the signal S by wavelet packet decomposition to level J, wherein the wavelet packet decomposition coefficients are D₀, D₁ . . . D_{2J-1}. Set a number i=1. Fit D with a liner function and subtracting the linear function from Dᵢ. Set i=i+1. Checking if i is equal to 2J−1; if not, redo previous two steps; if so, continue. Get a denoised signal from reconstruction of the wavelet packet decomposition coefficients; and write the denoised signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A shows a schematic diagram of the experimental setup according to an embodiment of the present invention.

FIG. 1B shows a scheme for the synchronization of the data acquisition process according to FIG. 1A.

FIG. 1C shows a binary tree of orthogonal wavelet packet decomposition down to level j.

FIG. 2 shows the power density distribution of a real signal according to an embodiment of the present invention.

FIG. 3A is the signal with harmonic cancellation.

FIGS. 3B-3G are the resampling signals with baseline fittings at 0, 60, 120, 180, 240, and 300 degrees.

FIG. 4A shows the noise baseline intensity with the signal induced by −150 mV test pulse in different phases.

FIG. 4B shows the phase of the ejected particles at 200 degrees of the applied RF driving phase.

FIG. 5A shows a flow chart of the denoising program according to an embodiment of the present invention.

FIG. 5B shows the flow chart of the RF interference reduction method according to an embodiment of the present invention.

FIG. 6A shows the real signal of a 0.7 μm polystyrene size standard sample.

FIG. 6B shows the denoised signal of a 0.7 μm polystyrene size standard sample.

FIG. 7 shows the flow chart of RF interference reduction method according to another embodiment of the present invention.

FIG. 8 shows data acquisition work flow of a voltage-scan charge detection rectilinear ion trap mass spectrometer (V-Scan CD-RIT MS).

FIG. 9 shows real background signal without a shielding case and guarding mesh. The RF frequency is set at 160 kHz and RF amplitude is scanned from 26 V to 130 V.

FIGS. 10a-i show (a) Raw signal of test pulse in time domain. The rf frequency is set at 14 kHz and the amplitude is scanned from 18 V to 90 V. (b) Approximated wavelet decomposition coefficients of (a). (c-i) detail wavelet decomposition coefficients at pth frequency sub-band of (a), those are d₃⁰, d₃¹, d₃², . . . , and d₃⁷, respectively.

FIGS. 11a-b show processing results of FIG. 10. (a) Signal processed by OWPD method. (b) Signal filtered by a band-stop filter with a bandwidth of 8 Hz at 14 kHz.

FIGS. 12a-d show (a) Raw mass spectrum of C₆₀. (b) Denoising result of (a). (c) Raw mass spectrum of cytochrome C. (d) Denoising result of (c).

### DETAILED DESCRIPTION

Orthogonal wavelet packet decomposition (OWPD) filtering approach to cancel harmonic interference noises arising from an AC power source in time domain and remove the resulting RF voltage interference noise from the mass spectra acquired by using a charge detection frequency-scan quadrupole ion trap mass spectrometer is adopted. With the use of a phase lock sampling technique, the transform coefficients of the RF interference in signals become a constant, exhibiting a shift of the baseline in different RF phases. The RF interference is therefore removable by shifting the baselines back to zero in OWPD coefficients. The approach successfully reduces the time-domain background noise from 1367 electrons (rms) to 408 electrons (rms) (an improvement of 70%) and removes the high frequency noise components in the charge detection ion trap mass spectrometry. Unlike other smoothing or averaging methods commonly used in the mass-to-charge (m/Ze) domain, our approach does not cause any distortion of original signals.

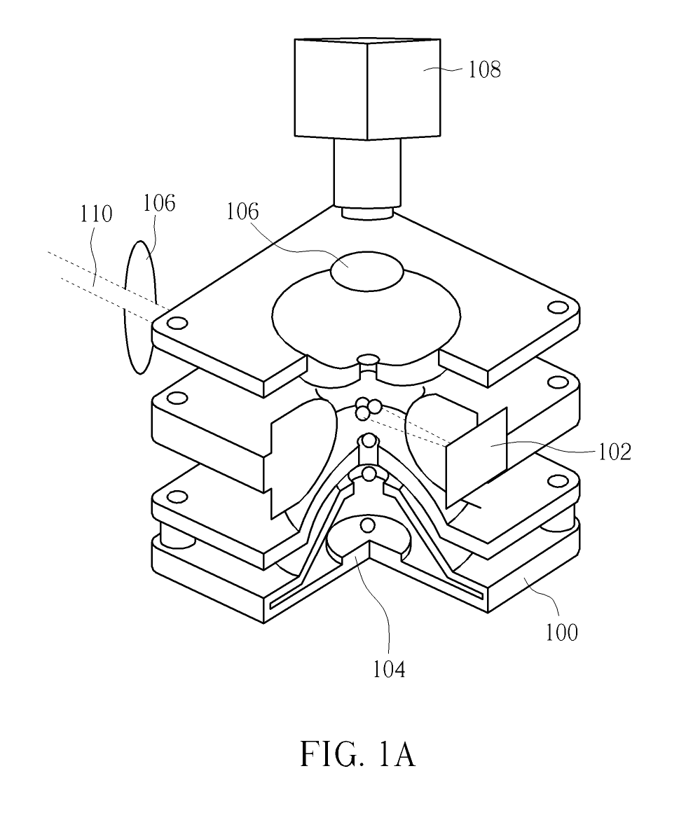

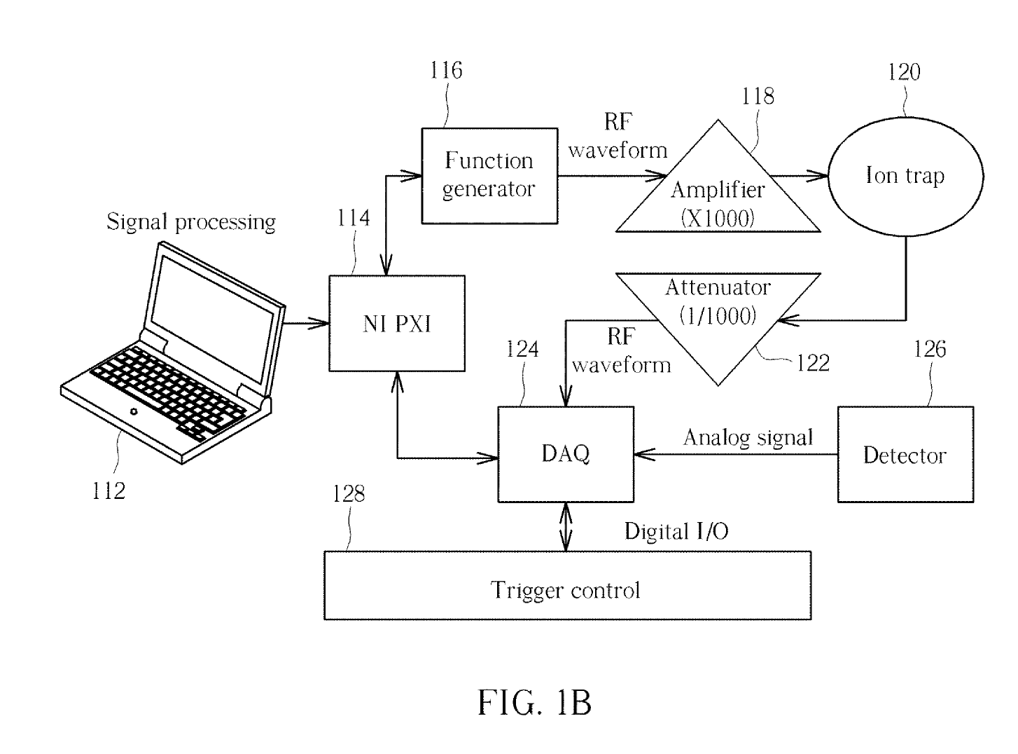

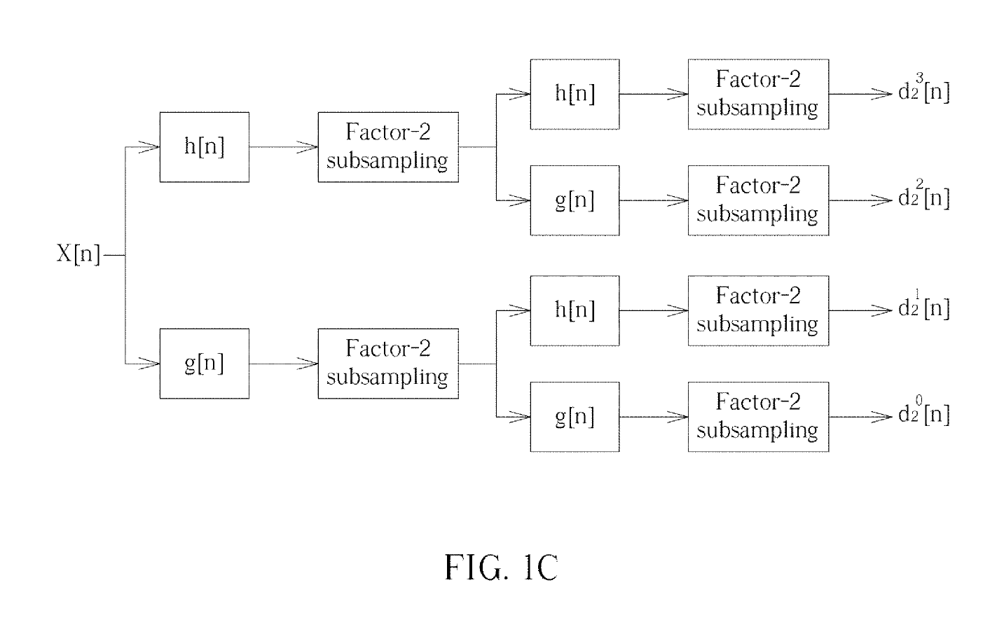

FIG. 1A shows a schematic diagram of the experimental setup according to an embodiment of the present invention. The experimental setup includes ion trap mass spectrometer 100, a charge-coupled device (CCD) 108, a charge detector 104, and lenses 106. A 0.4-mm-thick antimony-doped single-crystal silicon wafer 102 was used as the target plate. Samples of microparticles were loaded directly onto the target plate without a matrix and placed in one of the holes on the ring electrode of the quadrupole ion trap (QIT). A Nd:YAG laser beam 110 (λ=1064 nm, Q-switch) with a pulse duration of approximately 6 ns was shined directly onto the Si wafer 102 to desorb particles, which were subsequently captured by the QIT, with a power density of around 10⁷ Wcm⁻².

FIG. 1B shows a scheme for the synchronization of the data acquisition process according to FIG. 1A of the present invention. FIG. 1B includes a signal processing unit 112, a PCI (Peripheral Component Interconnect) eXtensions for instrumentation module 114, a function generator 116, a power amplifier 118, an ion trap 120, an attenuator 122, a data acquisition card 124, a detector 126, and a trigger control 128. Frequency scan of the QIT was conducted in a monopolar mode with 1000 steps per second for linear stepwise scan. The duration of each step was 1 millisecond. The function generator 116 (NI PXI 5402) provided the AC signal with a variable frequency at constant amplitude. The AC voltage was amplified by the power amplifier 118 and applied to the ring electrode. Both the end-cap electrodes were electrically grounded to reduce the noise interference. The trapped charged particles were ejected from the holes of the end-cap electrodes in a mass-selective axial instability mode by scanning the AC frequency. A home-built charge detector measured the absolute number of charges carried by the ejected particles. The ion signal was recorded by data acquisition (DAQ) card 124 (NI PXI 6133, National Instrument) and the sampling rate of DAQ card was set at 0.5 MHz.

A problem associated with the frequency scan is that the amplitude of the RF field varied with the frequency during the scan. To solve this problem, the DAQ card 124 also recorded the voltage (after attenuation) applied to the ring electrode to calibrate both the gain margin and phase margin. Both the function generator 116 and the DAQ card 124 were synchronized by PCI eXtensions for instrumentation (PXI) module 114(National Instrument).

The electronic calibration for the charge detector was carried out by applying an electrical pulse of known amplitude and shape to the “test pulse input” connector of the detector. The test data is collected under the frequency scan mode while the amplitude of the RF voltage was set as 850 V₀₋ₚ. The test pulse voltage was attenuated by two resistors with a factor of 1/100, and then fed to a 1 pF capacitor; the other terminal of the capacitor was virtually grounded to the amplifier input. The test pulse induced a charge Q in the Faraday plate as follows:

$$Q = 1 pF \frac{{V}_{test}}{100} \qquad ( 2 )$$

where Vₜₑₛₜ is the amplitude of the test pulse.

The real data are signals obtained by using LDCD-ITMS with polystyrene microparticles as the test samples. Polystyrene microparticles with the sizes of 2, 4, 6, 8 and 9 μm in diameter were purchased from Sigma-Aldrich, polystyrene microparticles with the size of 3.0 μm were obtained from the National Institute of Standards and Technology of the United States, and polystyrene microparticles with the size of 0.7 μm were obtained from Spherotech. All the polystyrene beads were thoroughly washed twice with deionized water and loaded onto the silicon wafer and air-dried.

Both the data were processed and algorithms were written by using LabVIEW (Professional, Version 8.6 for Windows, National Instrument). The computer configuration was an Intel Core i5 M450 at 2.4 GHz with 3.2 GB of RAM.

Orthogonal Wavelet Packet Decomposition and Reconstruction³⁰ (OWPD) is a mathematic tool useful for the development of denoising programs. In this method, the wavelet ψⱼ^{p} is split into a pair of wavelets whose spaces are orthogonal with each other by a pair of conjugate mirror filters g[n] and h[n]:

$$\begin{matrix}{ψ}_{j + 1}^{2 p} ( t ) = {\sum }_{n = - ∞}^{+ ∞} h [ n ] {ψ}_{j}^{p} ( t - {2}^{j} n ) & ( 3 ) \\ {ψ}_{j + 1}^{2 p + 1} ( t ) = {\sum }_{n = - ∞}^{+ ∞} g [ n ] {ψ}_{j}^{p} ( t - {2}^{j} n ) & ( 4 )\end{matrix}$$

We denote dⱼ^{p}[n] as the wavelet decomposition coefficients of the signal S( [symbol] ) in space Wⱼ^{p}, calculated as

dⱼ^{p}[n]= [symbol] S( [symbol] )|ψⱼ^{p}(t−2^{j}n)) [symbol] (5)

where [symbol] | [symbol] is an inner product. Similarly, the original signal S( [symbol] ) could be calculated by reconstruction until p=0 and j=0 by

dⱼ^{p}[n]=\check{d}ⱼ₊₁^{2p}★h[n]+\check{d}ⱼ₊₁^{2p+1}★g[n] (6)

where \check{d} is the data array obtained by inserting a zero between each two samples of d, and the symbol ★ meant discrete convolution.

By using Equations (3), (4), and (5), the signal could be decomposed to wavelet packet decomposition coefficients in different spaces which are orthogonal with each other. The noises of the signals are estimated and rejected in wavelet packet decomposition. FIG. 1C shows a binary tree of orthogonal wavelet packet decomposition down to level j. Both scaling function h[n] and wavelet function g[n] behave as a pair of a low pass filter and a high pass filter. This explains why one can obtain the approximated appearance of the original signal in the decomposition coefficients with the node p=0. Because dⱼ⁰[n] is operated by scaling the function with j times, the approximated appearance could be used to estimate the baseline of the signal. After ejection of the noises, Eq. (6) is used to reconstruct the decomposition coefficients of the denoised signal.

A model to describe the signal of LDCD-ITMS is as follows:

S( [symbol] )=Sₓ( [symbol] )+Nₕ( [symbol] )+N_{RF}( [symbol] )+N_{w}( [symbol] ) (7)

where the signal S( [symbol] ) obtained from LDCD-ITMS can be decomposed as a sum of four components: the signal without noises Sₓ( [symbol] ), the harmonic interference induced by the AC power source Nₕ( [symbol] ), RF interference from the applied driving voltage of the ion trap N_{RF}( [symbol] ) and the zero-mean Gaussian white noise N_{w}( [symbol] ). N_{w}( [symbol] ) is random and disordered. Here we concentrate on the discussion of the model of Nₕ( [symbol] ) and N_{RF}( [symbol] ).

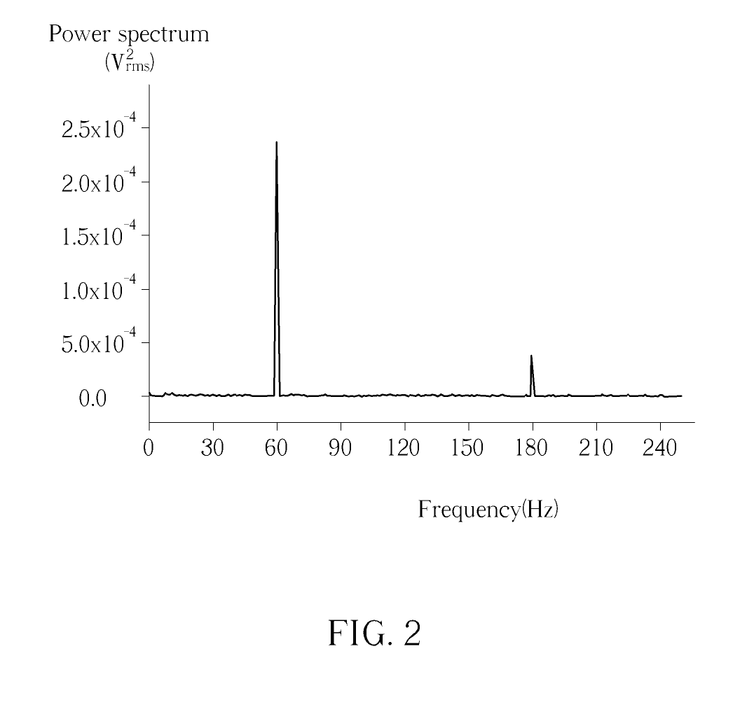

FIG. 2 shows the power density distribution of a real signal according to an embodiment of the present invention. We can observe the intensity of harmonic interference in FIG. 2. Nₕ( [symbol] ) is described as¹¹

$${N}_{h} ( t ) = {\sum }_{i = 1}^{ℋ} {γ}_{i} sin ( 2 π {v}_{i} t + {ϕ}_{i} ) \qquad ( 8 )$$

γᵢ, νᵢ and φᵢ are the amplitude, frequency and the initial phase of [symbol] th harmonic. [symbol] is the highest order of harmonics, and νᵢ= [symbol] ×ν₁, where ν₁ is base frequency of the harmonics. Symbol [symbol] is time.

The RF interference (N_{RF}( [symbol] )) is induced by applied RF driving voltage of QIT (V_{RF}( [symbol] )), and we assume that N_{RF}( [symbol] ) is linearly proportional to V_{RF}( [symbol] ).

N_{RF}( [symbol] )=εV_{RF}( [symbol] )=ε [symbol] sin(2π [symbol] ( [symbol] )) (9)

where ε is the coefficient of interference, the value of ε depends on the RF strength, [symbol] is the amplitude of the RF driving voltage, and [symbol] ( [symbol] ) is the phase of driving voltage of QIT. The gain margin of [symbol] can be ignored because the effect is negligible in N_{RF}. Since we generate the frequency scan waveform by phase-continuous frequency hopping, the [symbol] ( [symbol] ) is described as

$$p ( t ) = {f}_{⌊ \frac{t}{Δ t} ⌋} ( t \% Δ t ) + {\sum }_{k = 0}^{⌊ \frac{t}{Δ t} ⌋ - 1} {f}_{k} Δ t + \frac{φ {f}_{k}}{2 π} \qquad ( 10 )$$

where Δ [symbol] is the duration that stays at a certain frequency, └ ┘ is the round down operator, fₖ is the frequency at stepwise sweep frequency step k, φ_{f}_{ₖ} is the phase shift at fₖ which can be estimated by tone analysis according to the read back value from QIT driving voltage, and % indicates the modular.
The number of steps is set as [symbol] , the frequencies of a linear frequency stepwise scan are described as

$${f}_{k} = \frac{k}{𝒦} ( {f}_{f} - {f}_{i} ) + {f}_{i} \qquad ( 11 )$$

fᵢ and f_{f} are the initial frequency and the final frequency in a frequency scan.

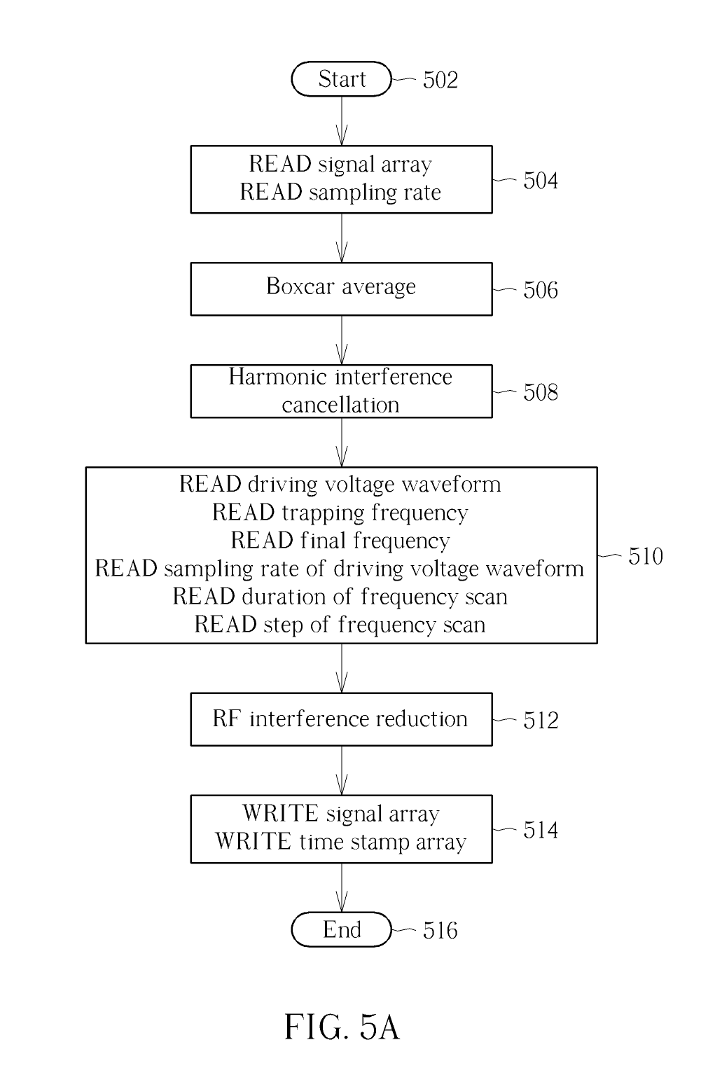

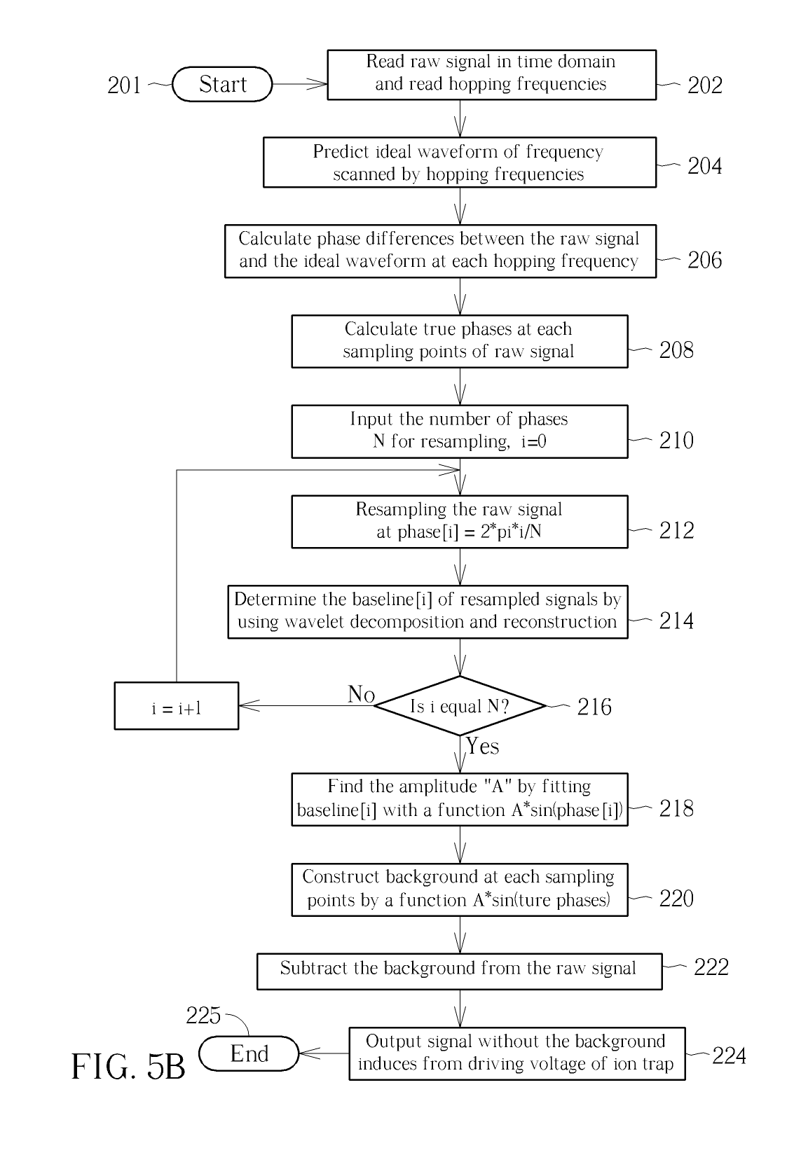

Using above feature model of noises, a denoising program has developed to remove Nₕ and N_{RF}, and reduce N_{w}. The flow chart of the denoising program 500 is shown in FIG. 5A. the flow chart of the denoising program 500 may include the following steps:
Step 502: Start.
Step 504: Read a signal raw data array observed in the spectrometer and read sampling rate.
Step 506: Process the signal raw data array by Boxcar averaging method to obtain a first signal array.
Step 508: Process the first signal array by a harmonic interference cancellation method to obtain a second data array.
Step 510: Read driving voltage waveform, read trapping frequency, read final frequency, read sampling rate of driving voltage waveform, read duration of frequency scan, and read step of frequency scan.
Step 512: Process the second signal array by a radio frequency (RF) interference reduction method.
Step 514: Reconstruct a third signal array without the background induced from driving voltage of ion trap according to the second signal array.
Step 516: End.

The denoising program 500 includes of three major algorithms: Boxcar averaging, harmonic interference cancellation, and RF interference reduction.

With regard to Boxcar averaging algorithm, before we do the OWPD, the size of datasets is reduced by Boxcar averaging to enhance the computing speed and reduce the white noise. The sampling rate of raw data sets after Boxcar averaging should keep four hundred times of the initial frequency during a frequency scan, which can ensure raw datasets have enough resolution to reconstruct the RF interference array.

With regard to Harmonic Interference Cancellation, Harmonic interference cancellation was mentioned by Xu¹¹. The first step is to resample raw signals with sampling rate fᵣₛ.

fᵣₛ=ν₁×2^{J} (12)

where ν₁ is the base frequency of harmonics and J is the decomposition level, fᵣₛ is the resampling rate which is the closest number to sampling rate after Boxcar averaging.

The signal with OWPD is decompose to level J. The decomposition coefficients of the signal and those four components of Eq. (7) are described as

d_{J}^{p}[n]=dSₓ_{_{J}}^{p}[n]+dNₕ_{_{J}}^{p}[n]+dN_{RF}_{_{J}}^{p}[n]+dN_{w}_{_{J}}^{p}[n] (13)

The model of harmonic interference has been discussed in Eq. (8). It is found only ½^{J} of samples of Nₕ( [symbol] ) are retained by dNₕ_{_{J}}^{p}[n] with a factor 2^{J} subsampling of level J, and can be described by

$$\begin{matrix}{dN}_{hj}^{p} [ n ] = {\sum }_{i = 1}^{L} {Y}_{i}^{′} sin ( 2 πin + {ϕ}_{i} ) \\ = {\sum }_{i = 1}^{L} {Y}_{i}^{′} sin ( {ϕ}_{i} )\end{matrix} \qquad ( 14 )$$

The Eq. (14) shows that the harmonics becomes a nonzero baseline in OWPD coefficients d_{J}^{p} but the other three coefficients (dSₓ_{_{J}}^{p} dN_{RF}_{_{J}}^{p} and dN_{w}_{_{J}}^{p}) are zero mean³⁰. If we move the nonzero baseline in d_{J}^{p} back to zero and then do a hard threshold to d_{J}^{p} we can get d_{J}^{p} with the reduced white noise level and without the harmonic interference. Finally, we reconstruct d_{J}^{p}

With regard to RF Interference Reduction algorithm, the flow chart of the RF interference reduction method 200 is shown in FIG. 5B and may include following steps:
Step 201: Start.
Step 202: Read a raw signal in time domain and read hopping frequencies.
Step 204: Predict ideal waveform of frequency scanned by the hopping frequencies.
Step 206: Calculate phase differences between the raw signal and the ideal waveform at each hopping frequencies.
Step 208: Calculate true phases at each sampling point of the raw signal.
Step 210: Input a number i of phases N for resampling, beginning with i=0.
Step 212: Resample the raw signal at phase [i]=2*pi*i/N, where pi is the ratio of a circle's circumference to its diameter.
Step 214: Determine the baseline [i] of resampled signals by using wavelet decomposition and reconstruction.
Step 216: Check if i is equal to N; if so, i=i+1 and go to step 212; if not, go to step 218.
Step 218: Find an amplitude A by fitting baseline [i] with a function A*sin(phase [i]).
Step 220: Construct background at each sampling points by a function A*sin(true phases).
Step 222: Subtract the background from the raw signal.
Step 224: Output a signal without the background induced from driving voltage of ion trap.
Step 225: End.
   In order to reduce the RF interference, the scan time is set 1 second, and the duration of scan step is 1 milisecond in linear stepwise frequency scan. To reduce the RF interference, the scan time is set 1 second, and the duration of scan step is 1 milisecond in linear stepwise frequency scan. The maximum value of phase [symbol] ₘₐₓ of a frequency scan is calculated by Eq. (10). We create a two-dimension array [symbol] ᵣₛ[ [symbol] 101 , [symbol] 102 ] as

$${p}_{rs} [ m , n ] = n + \frac{m}{360} \\ \{ m , n \} ∈ ℤ , \\ 0 \leq m < 360 , \\ and \\ {p}_{rs} [ m , n ] < {p}_{max} \qquad ( 15 )$$

where [symbol] 101 and [symbol] 102 are indexes of row and column. We calculate the time stamp array [symbol] ᵣₛ[ [symbol] 101 , [symbol] 102 ] by doing linear interpolation of Eq. (10) using [symbol] ᵣₛ[ [symbol] , [symbol] ]. Then we interpolate the signal (S) with timestamp [symbol] ᵣₛ [ [symbol] , [symbol] ], i.e.

S[ [symbol] , [symbol] ]=S( [symbol] ᵣₛ[ [symbol] , [symbol] ]) (16)

where the RF interference in two-dimension array S[ [symbol] , [symbol] ] is as

$$\begin{matrix}{N}_{RF} [ m , n ] = ɛ A sin ( 2 π p ( {t}_{rs} [ m , n ] ) ) \\ = ɛ A sin ( 2 π {p}_{rs} [ m , n ] ) \\ = ɛ A sin ( 2 π ( n + \frac{m}{360} ) ) \\ = ɛ A sin ( 2 π \frac{m}{360} )\end{matrix} \qquad ( 17 )$$

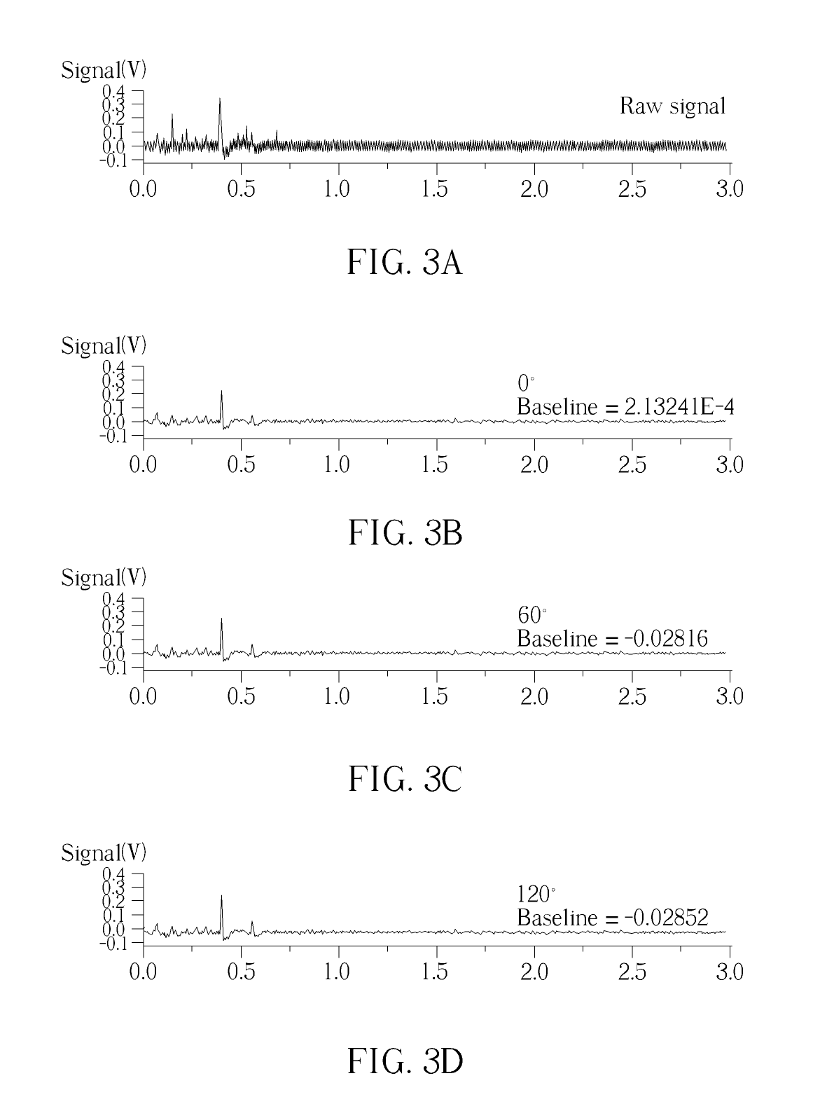

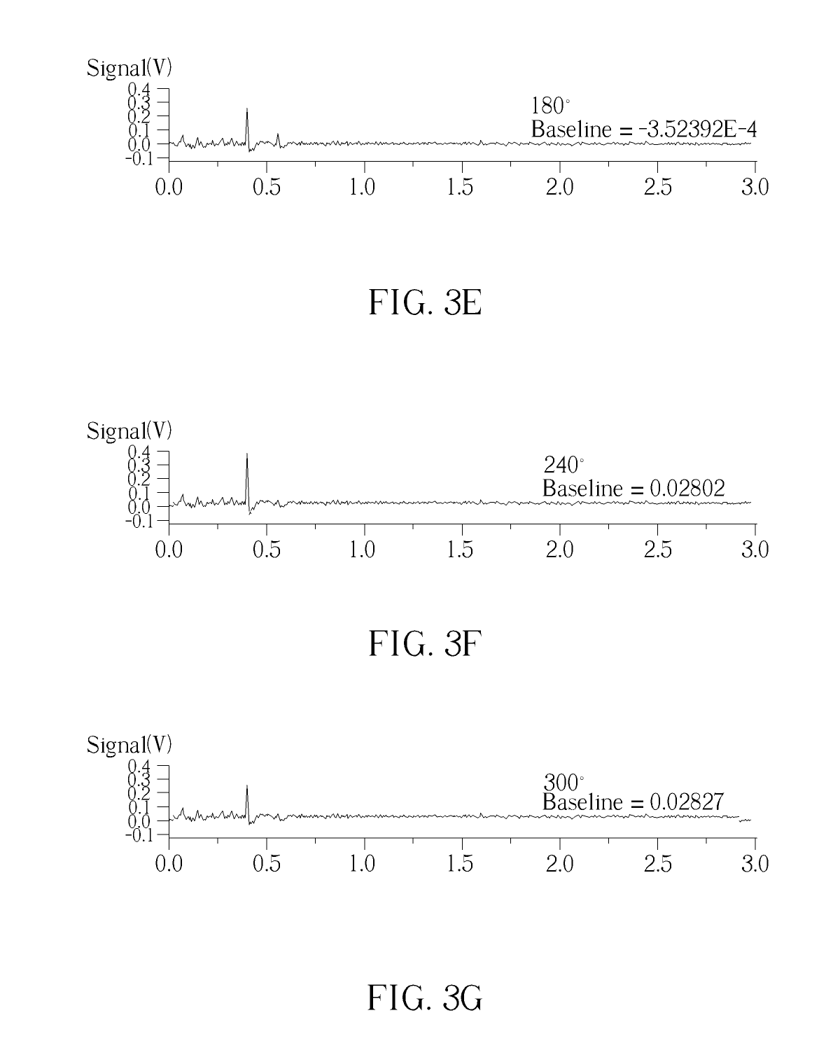

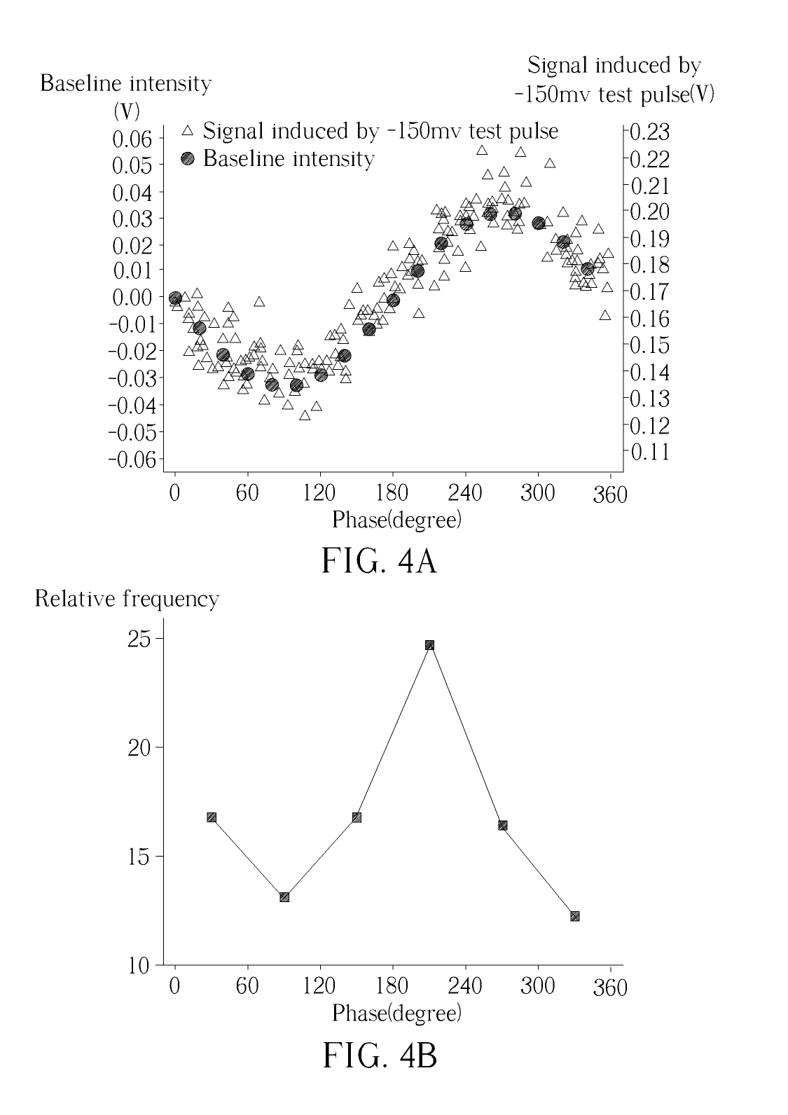

N_{RF}[ [symbol] , [symbol] ] is a constant in a signal if the phases of the driving voltage are the same. In other words, S[ [symbol] , [symbol] ] has a nonzero baseline, which is induced by N_{RF}, in each row. The resampling signal S[ [symbol] , [symbol] ] is shown in FIGS. 3A to 3G, where FIG. 3A is the signal with harmonic cancellation. FIGS. 3B to 3G are the resampling signals and their baseline fittings are at 0, 60, 120, 180, 240, and 300 degrees. In order to clearly observe the noise characteristics of the charge detector under the influence of strong RF field, we conduct noise measurement with the known test pulses as input and record the output response of charge detector in a frequency scan mode while the driving voltage of QIT is set as 850 V. FIG. 4A shows the noise baseline intensity with the signal induced by −150 mV test pulse in different phases. We found the shift in measured noise baseline intensity is matched to the measured test pulse signal. This means the RF driving voltage will produce an interference which is linearly combined with the sinusoidal signal according to Eq. (9). FIG. 4B shows the phase of the ejected particles at 200 degrees of the applied RF driving phase. At the phase of 200 degrees, the ejected population is ˜25%. This means that N_{RF} not only induces a wider noise distribution, but also causes a systematic error in charge measurement.

As for how to remove the RF interference in signals, each row of S[ [symbol] , [symbol] ] by OWPD until J=2 of d_{J}^{p} in Eq. 5 for baseline estimation. The decomposition coefficients are d[ [symbol] , [symbol] ]₂⁰, d[ [symbol] , [symbol] ]₂¹, d[ [symbol] , [symbol] ]₂², and d[ [symbol] , [symbol] ]₂³. The scaling function h[n] is a low pass filter and d[ [symbol] , [symbol] ]₂⁰ is operated by h[n] with two times. We refer d[ [symbol] , [symbol] ]₂⁰ to an approximated coefficient. We estimate the baseline b[ [symbol] ] in d[ [symbol] , [symbol] ]₂⁰ by fitting with a horizontal linear line, and then remove the nonzero baseline back to zero as

d[ [symbol] , [symbol] ]₂⁰^{^{†}}=d[ [symbol] , [symbol] ]₂⁰−b[ [symbol] ] (18)

Now the S[ [symbol] , [symbol] ] is reconstructed by using the new decomposition coefficient d[ [symbol] , [symbol] ]₂⁰^{^{†}} and all other three decomposition coefficients d[ [symbol] , [symbol] ]₂¹, d[ [symbol] , [symbol] ]₂², and d[ [symbol] , [symbol] ]₂³. Finally, S[ [symbol] , [symbol] ] is rearranged to a one-dimensional array by using time stamp [symbol] ᵣₛ[ [symbol] , [symbol] ] arranged from low to high.

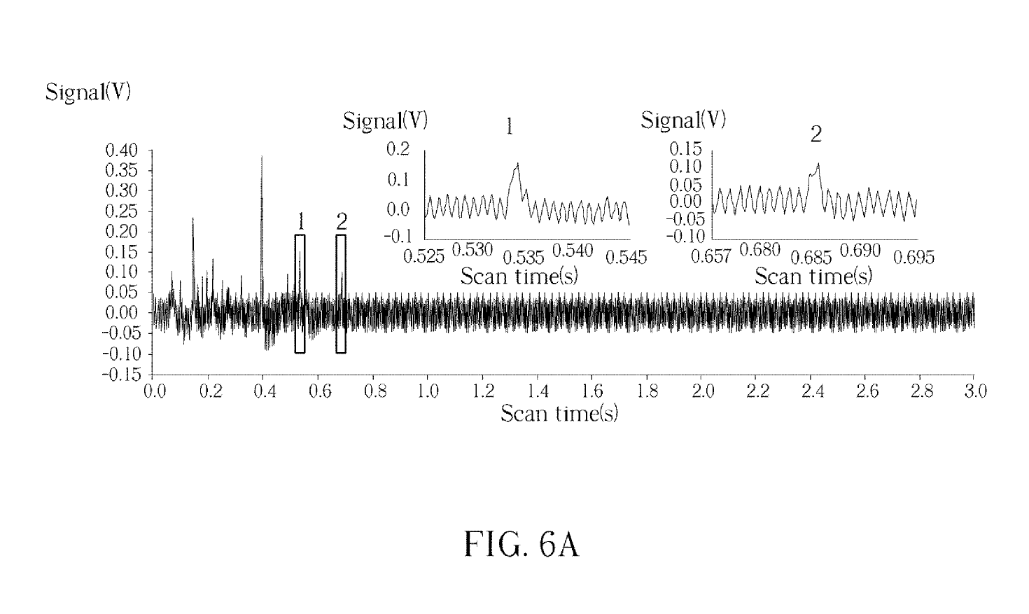

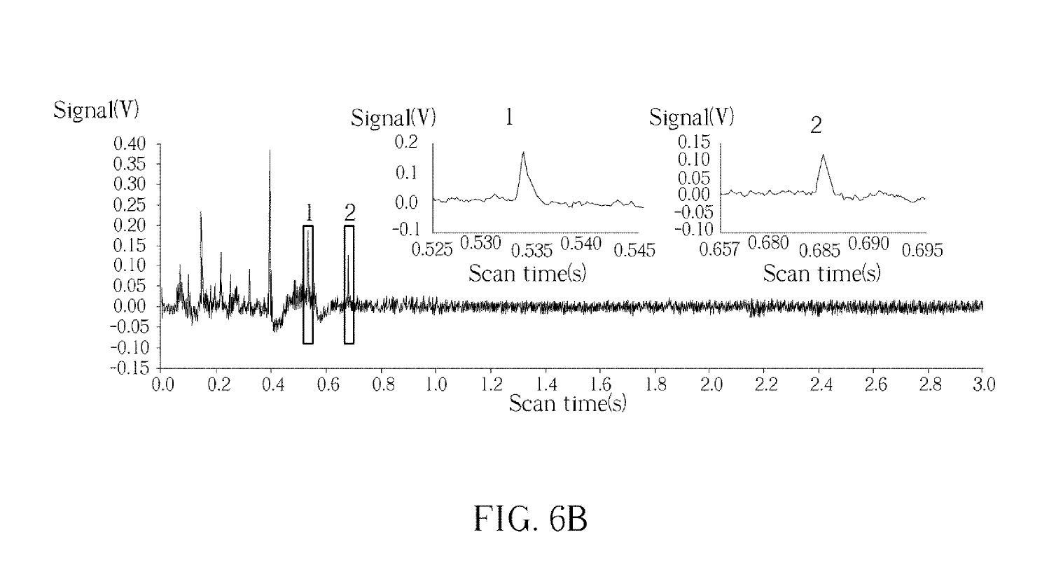

Shown in FIG. 6A and FIG. 6B are the real signal and denoised signal of a 0.7 μm polystyrene size standard. It is obvious that more peaks can be distinguished after denoising. In FIG. 6A, RF interference is clearly observed and causes significant distortion. The reason for this distortion is that the trapping frequency of QIT is higher than the response speed of detector. The S/N ratios of peak 1 and peak 2 in FIG. 6A are 6.52 and 4.80. FIG. 6B shows the distorted peaks are superimposed to real peak shape. The S/N ratios of peak 1 and peak 2 are 21.7 and 15.4 after denoising. The OWPD based RF cancellation algorithm successfully removes the distortion. The root-mean-square values of those noises are calculated, and the noise background is equal to 24.1 mV (1366 electrons). After denoising, the noise background is reduced to 7.2 mV (408 electrons). The noise components in FIG. 6B are very close to white noise. To sum up, in LDCD-ITMS, the noise is reduced 70% by the denoising program and the detection limit (a signal greater than three times the standard deviation of the noise level) is improved from 72.3 mV (4100 electrons) to 21.6 mV (1225 electrons). When trapping nanoparticles, the trapping frequency should be tuned higher than 1 kHz. In this condition, the S/N ratios will be greatly improved by removing the superimposed RF noises in real signals.

To discuss the noise components of the charge detector, the test pulse is used to measure the response signals. The noise intensity of N_{RF} obtained in experiment is about 32 mV (V0−p), which is converted to 22.6 mVrms (1283 electrons) in root-mean-square value as shown in FIG. 4A.

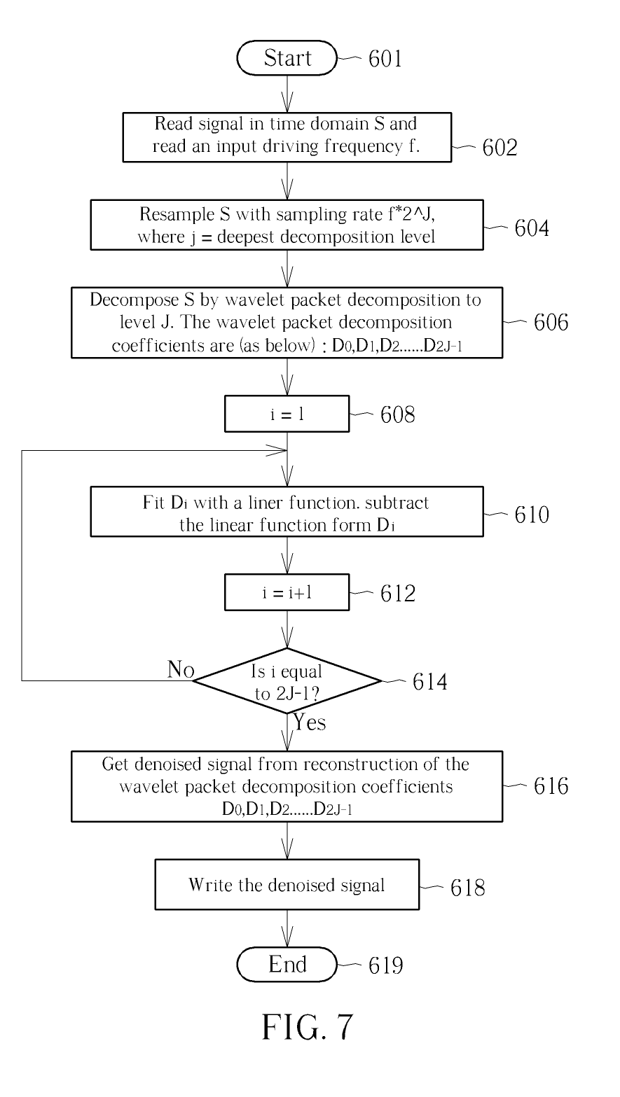

In another embodiment, RF interference reduction method 700 may be applied to voltage-scan ion trap mass spectrometer. The flow chart of RF interference reduction method 700 is shown in FIG. 7 and may include following steps:
Step 601: Start.
Step 602: Read a signal S in time domain and read an input driving frequency f.
Step 604: Resample the signal S with a sampling rate f*2̂J, where J is the deepest decomposition level.
Step 606: Decompose the signal S by wavelet packet decomposition to level J, where the wavelet packet decomposition coefficients are D₀, D₁ . . . D_{2J-1}.
Step 608: Set a number i=1.
Step 610: Fit D with a liner function and subtracting the linear function from Dᵢ.
Step 612: Set i=i+1.
Step 614: Check if i is equal to 2J−1; if not, go to step 610; if so, go to step 616.
Step 616: Get a denoised signal from reconstruction of the wavelet packet decomposition coefficients.
Step 618: Write the denoised signal.
Step 619: End.

The signal S and the input frequency f are read at electrodes of the voltage-scan ion trap mass spectrometer. The signal S is resampled by linear interpolation with a resampling rate and J is the deepest decomposition level of wavelet packet decomposition. D₀ is an approximated coefficient of OWPD and the D₁ . . . D_{2J-1} are detail coefficients of OWPD. The wavelet packet decomposition coefficients are reconstructed back to J=0 so as to get a signal without RF interference.

In summary, a denoising program based on an OWPD method to effectively remove the interference induced by the applied RF driving voltage which is inevitably present in LDCD-ITMS is developed. The program shows high efficiency in eliminating the RF-induced noise, removing the harmonics from the AC power source, and reducing the white noise level by Boxcar averaging with wavelet decomposition coefficient threshold. Tested with the induced RF signals from the charge detector, the method successfully reduces the noise level in charge detection from 1367 to 408 electrons and improves the detection sensitivity limit by about 70%. The approach is expected to be useful to remove the interferences from the applied high RF voltages used in various types of mass spectrometers, including quadrupole ion trap, linear ion trap, Fourier transform ion cyclotron resonance, and orbitrap mass spectrometers^{34,35}, and may be applied to both frequency-scan and voltage-scan ion mass spectrometers.

In another embodiment, RF interference is removed from a charge detection voltage-scan rectilinear (linear) ion trap mass spectrometer as follows.

A linear ion trap (LIT) is a popular trap device on account of its high ion trapping capacity and MSⁿ ability.¹⁻³ It is widely used in hybrid instruments, such as a Fourier transform ion cyclotron resonance mass spectrometer and an Orbitrap mass analyzer for biomolecular mass analysis.⁴⁻⁷ Currently, the detection mass range of an LIT is only mass-to-charge ratio of 4,000 as its RF driving frequency is typically set at 1 MHz and its poor secondary electron conversion efficiency leads to insufficient signals of high mass ions. In order to extend the detection mass range of an LIT, Chen et al. developed a frequency-scan LIT mass spectrometer to lower the RF driving frequency and used secondary charge detector to generate ion signals at very high voltage (˜30 kV).⁸ While using a secondary charge detector, strong arcing and low secondary electron efficiency will limit its detection of high mass ions.

To deal with the above two problems, a charge detector was introduced to couple with a quadrupole ion trap (QIT)⁹⁻¹⁶, which shows no poor detection efficiency in detecting high mass ions and suitable to detect single cells, polystyrene particles and IgM ions. However, QIT cannot provide high ion trapping efficiency with simple geometry and enough mass resolution due to a low space charge effect while a rectilinear ion trap (RIT)^{1, 17, 18} a kind of LIT, can. IA charge detection rectilinear ion trap (CD-RIT) mass spectrometry is proposed that couples a charge detector and an RIT/LIT that demonstrates the promising detection of high mass ions. It was found that the coupled charge detector and RIT/LIT faces a serious RF field interference problem. If the RF interference is solved, the desired coupling of a charge detector and RIT is possible. Therefore, in this section, the RF problem when coupling charge detector and RIT is addressed.

In order to overcome the RF problem, a shielding case with guarding mesh is added to reduce the strong RF field by waveguide cavity theory.¹⁹ The waveguide cavity can confine the strong RF field inside the trap and will not saturate the charge detector. However, this strong RF field cannot be fully reduced with the cavity only. Therefore, an algorithm based on orthogonal wavelet packet decomposition (OWPD) theory is developed to completely remove the RF interference without any signal distortion.^{20,21}

To reduce all noise interferences from a voltage-scan CD-RIT mass spectrometer. An observation model of time domain signal S is described as

S=Sₓ+N_{rf}+Nₕ+N_{w} (19)

where Sₓ is the signal induced by ions, N_{rf} is the interference induced by RF field, Nₕ is the sum of harmonics induced by AC power source, and N_{w} is white noise. Both Nₕ and N_{w} are common noises in instruments, these two noises can be minimized by suitable cable connection and instrumentation design. The rejection of Nₕ and N_{w} by signal processing methods were widely studied.^{20, 22-28} Therefore, in this study, we focus to build a denoising model of N_{rf}. We assume N_{rf} is proportional to the intensity of RF electric field and the N_{rf} is written as following

$${N}_{rf} ( t ) = {\sum }_{i = 1}^{l} {ρ}_{i} ( t ) \qquad ( 20 )$$

where t is time, ρᵢ(t) is RF interference which is proportional to the RF driving voltage of ith electrode at time t.²¹ As shown in equation 20, N_{rf} is a superposition result of interferences from the RF voltages at each electrode. In voltage-scan mode, ρᵢ(t) in equation (20) is a product of a straight line and a sinusoidal wave of RF driving voltage (f_{rf}). In general, the N_{rf} can be reduced by band-stop filters (i.e. notch filters) but those will cause distortions in Sₓ.^{22, 29} Those distortions will be even seriously and enlarged when the RF frequency is close to the frequency of Sₓ.²⁹ Since the detection of high mass ions will employ lower RF trapping frequency which is close to the signal frequency and thus the signal could not be retrieved by conventional band-stop filters. Besides band-stop filters cannot be used to reject RF interference completely with only finite signal length.²⁹ An even worse result is that distortion will destroy the peak sharp of signal from the charge detector. Therefore the absolute charge number of ions will be measured wrong.

To get a distortion-free signal from a voltage-scan CD-RIT mass spectrometer, an algorithm based on orthogonal wavelet packet decomposition (OWPD) theory is proposed. The OWPD is widely used in digital signal processing to decompose the raw signal to different levels of band-pass filtered results in time domain. A specific setting on sampling rate of signal makes N_{rf} easily estimated and removed after OWPD. We therefore can reconstruct the decomposed signals back to the raw signal without distortions and RF interference.²⁰ By employing both a waveguide cavity and the RF removal algorithm, mass spectra of C₆₀ and cytochrome C (cyt C) without any distortions can be obtained. Results demonstrate that CD-RIT mass spectrometer can detect high mass MALDI ions without RF interference and might be beneficial for high mass analysis using LIT and LIT-hybrid instruments.

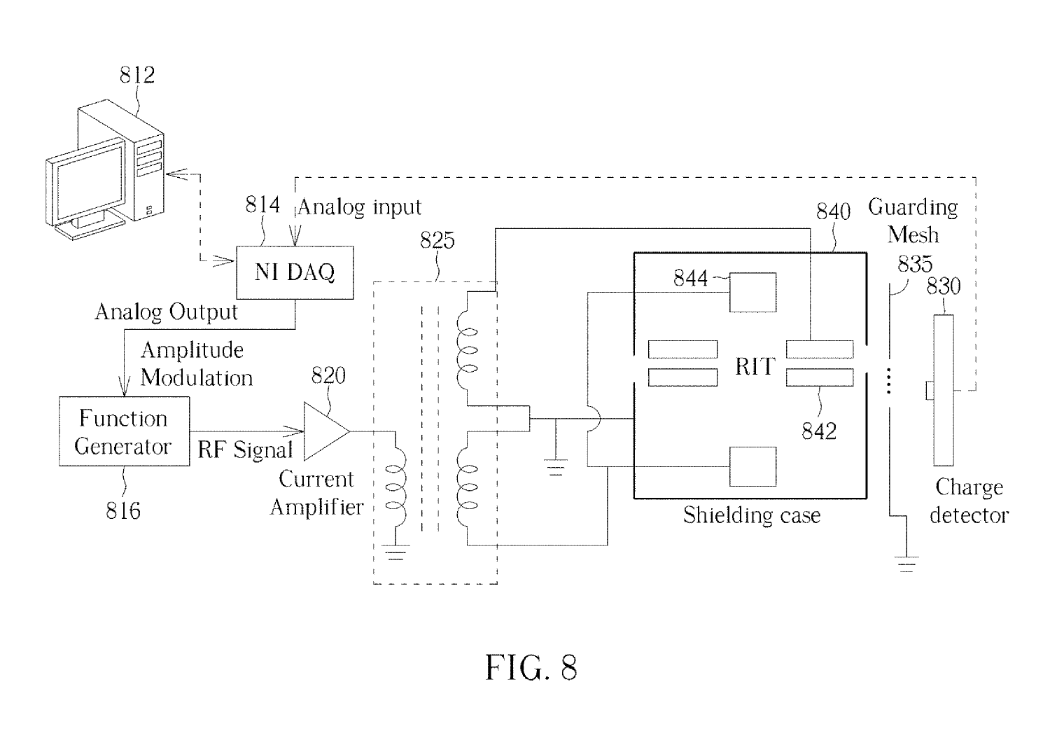

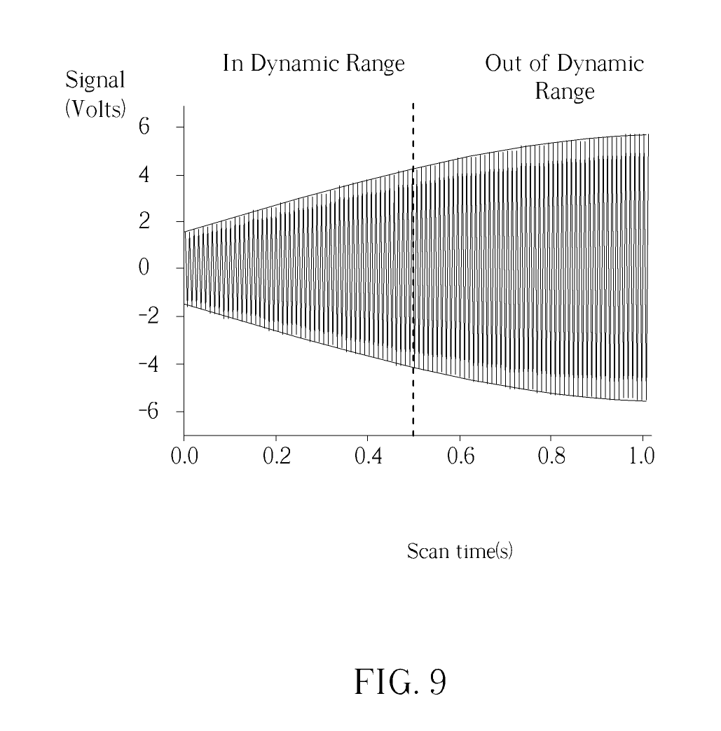

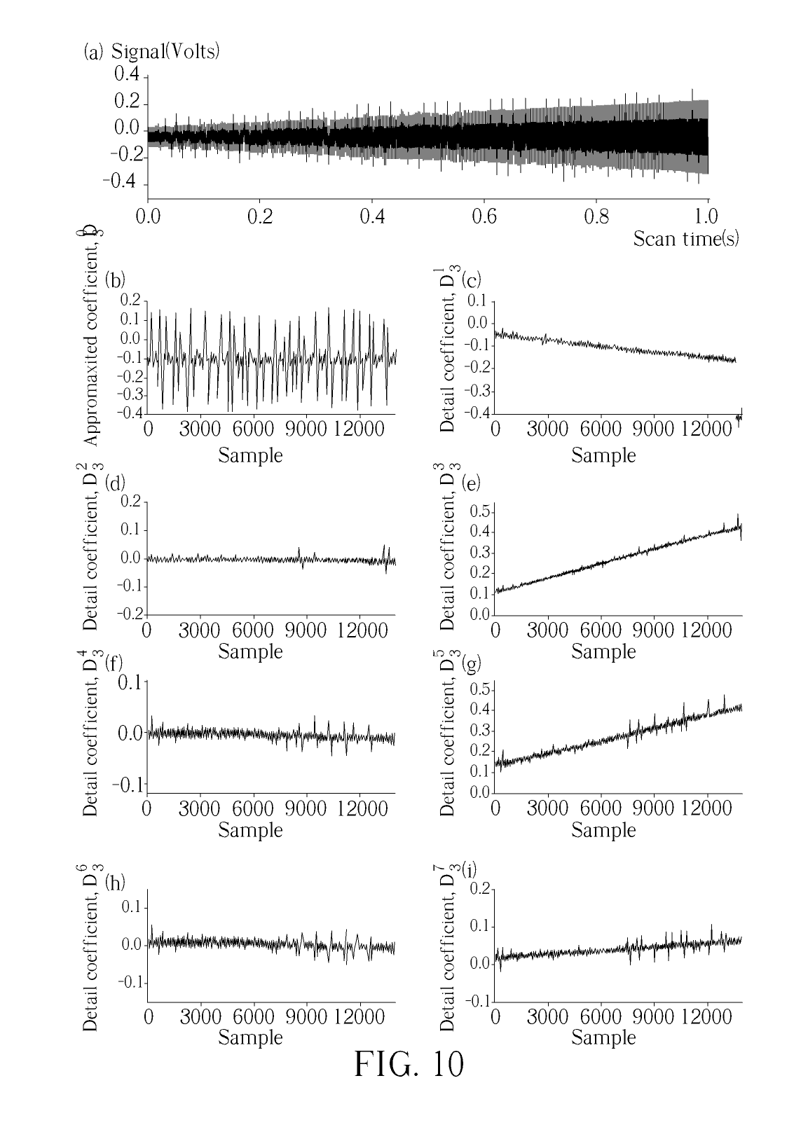

The data acquisition work flow is shown in FIG. 8. Briefly, the apparatus comprises a rectilinear ion trap (RIT) 842, 844 as the mass analyzer, a function generator 816, a current amplifier 820, a transformer 825, a charge detector 830, a data acquisition (DAQ) card 814, a computer 812, and a waveguide cavity including a shielding case 840 and a guarding mesh 835. The shielding case 840 surrounds the rectilinear ion trap (RIT) 842, 844 and the guarding mesh 835 is disposed between an opening in the shielding case 840 and the charge detector 830.

The amplitude of an RF sinusoidal signal is provided by function generator which amplitude is modulated from the analog output of DAQ card. The RF signal is amplified by a power amplifier which is consisted of a current amplifier and a transformer, and then applied to the electrodes of RIT. The charge detector is consisted of three parts: a Faraday plate, a charge integral circuit, and a band-pass filtering circuit. An image charge is induced while the ions are closing to Faraday plate. The charge integral circuit senses the image charges and outputs a voltage signal which is filtered by a band-pass filtering circuit. RF voltage is set at low level in the trapping period and cooling period, and RF amplitude is set to scan linearly. The charge detector senses an induced imaging charge signal when the ejected ions hit the detector plate. Ion signals are recorded by a DAQ card and the acquired mass spectra are stored in a computer.

In FIG. 8, shielding of the RF electric field is accomplished by covering the rectilinear ion trap (RIT) 842, 844 with the shielding case 840, which may be a stainless steel case in some embodiments. The guarding mesh 835 is placed between an opening in the shielding case 840 and the charge detector 830. The guarding mesh 835, which may be a nickel mesh in some embodiments, is used to allow the transmission of ions to the charge detector 830 and reduces the RF electric field. Both the shielding case 840 and the guarding mesh 835 can reduce RF interference according to waveguide cavity theory.³⁰ FIG. 9 is the background signal obtained from charge detector with a RF frequency of 160 kHz. RF amplitude is scanned from 26 V to 130 V without the shielding case 840 and guarding mesh 835. The output dynamic range of the charge detector 830 is below 4V. The strong RF field causes the output of charge detector 830 beyond this dynamic range when the RF driving voltage of RIT is above 70 V.

A test pulse is used to calibrate the output signal and image charge induced by charge detector 830.¹⁰ The test pulse voltage is attenuated by two resistors with a factor of 1/100, and then fed to a 1 pF capacitor; the other terminal is coupled with 1 pF capacitor to the Faraday plate. The induced charge from test pulse Vₜₑₛₜ in Faraday plate is

$$1 pF \frac{{V}_{test}}{100} .$$

When analyzing high mass ions, RF driving frequency must be set to a lower frequency, however, the induced RF interference will be very hard to be removed completely by traditional band-stop filters. OWPD approach, on the other hand does not face this difficulty. To compare the difference between band-stop filters and OWPD, we simulate the signal by inputting a test pulse of square wave (20 Hz 500 mVₚ₋ₚ) into the charge detector 830 in a voltage-scan condition, where the driving RF frequency is set at 14 kHz and scanned from 18 V to 90 V. Both band-stop filter and OWPD methods are demonstrated to remove the RF interference using test pulse.

The protein, cytochrome C from horse (12327 Da), was purchased from Sigma. All analytical grade reagents, MALDI matrices and fullerene (C₆₀, purity >99%, with C₇₀ as major impurity) were purchased from Aldrich. All analytes were used as received. Deionized water was purified to 18.2 MΩ/cm by Milli-Q water purification system (Millipore, Billerica, Mass.).

Herein, we used Li's two-layer sample preparation method³¹ to prepare protein samples in which the matrix solution with concentration of 6 mg/mL in 60% Methanol/acetone (v/v) of sinapinic acid (SA) was placed and dried on a sample probe to form a microcrystal as the first layer. Then a solution containing both analytes and matrix was added to the top of the matrix layer as the second layer. The second matrix layer solution was prepared in 50% acetonitrile/water (v/v) which contained 0.1% trifluoroacetic acid with concentration of 1 mg/100 μL for SA.

Saturated fullerene (C₆₀) solution was prepared in toluene which is used as mass calibration standard. Roughly, 8 μL mixture of sample and matrix was added onto the stainless sample probe (8 mm diameter) and then air-dried.

The trapping voltage for C₆₀ is 60 V and then scanned to 300 V at RF frequency of 180 kHz. The trapping voltage of cyt C is 112 V and then scanned to 560 V at RF frequency of 80 kHz.

The data were processed and algorithms were written by LabVIEW (Professional, version 8.6 for Windows, National Instrument, Austin, Tex.). The computer configuration was an Intel Core i5 M450 at 2.4 GHz with 3.2 GB of RAM.

Orthogonal wavelet packet decomposition (OWPD) is a math tool which is used in developing an RF interference cancellation algorithm. According to the OWPD, a signal Y in space Vⱼ^{p} is decomposed in a pair of orthogonal subspaces which are an approximated space Vⱼ₊₁^{2p} and a detail space Vⱼ₊₁^{2p+1} where j is the decomposition level and the (j,p) is the pth node at level j, j≦J where J is the deepest level of decomposition.²⁰ The Vⱼ^{p} admits an orthonormal basis [symbol] . The root space of binary decomposition V₀⁰ is the space of original signal which admits a canonical basis of Diracs

$${\{ {Ψ}_{0}^{0} [ m - n ] = δ [ m - n ] \}}_{n ∈ ℤ} .$$

²⁹ The basis Ψⱼ^{p} of Vⱼ^{p} is decomposed to two orthonormal bases Ψⱼ₊₁^{2p} of V^{j+1}^{2p} and Ψ^{j+1}^{2p+1} of Vⱼ₊₁^{2p+1} by a pair of conjugate mirror filters g[n] (low-pass filter) and h[n] (high-pass filter) as following²⁰:

$$\begin{matrix}{ψ}_{j + 1}^{2 p} [ m ] = {\sum }_{n = - ∞}^{+ ∞} g [ n ] {ψ}_{j}^{p} [ m - {2}^{j} n ] & ( 21 ) \\ {ψ}_{j + 1}^{2 p + 1} [ m ] = {\sum }_{n = - ∞}^{+ ∞} h [ n ] {ψ}_{j}^{p} [ m - {2}^{j} n ] & ( 22 )\end{matrix}$$

The decomposition result of signal Y in space Vⱼ^{p} is

$${d}_{j}^{p} [ m ] = {\sum }_{n = - ∞}^{+ ∞} Y [ n ] {Ψ}_{j}^{p} [ n - {2}^{j} m ] \qquad ( 23 )$$

where the bases Ψⱼ^{p} work as band-pass filters, therefore, the dⱼ^{p} are the wavelet decomposition coefficients in the pth frequency sub-band at level j. The dⱼ⁰ is the approximated coefficients at level j, while the dⱼ^{p}(0<p<2^{j}) are the detail coefficients in the pth detail sub-bands at level j. Equation (23) shows that Y is subsampled by factor 2^{j}, only 1/2^{j} of the samples of Y is retained by dⱼ^{p}.

The original signal Y can be reconstructed by following reconstruction equation at each p and j until d₀⁰=Y is obtained

dⱼ^{p}[m]=\check{d}ⱼ₊₁^{2p}★g[m]+\check{d}ⱼ₊₁^{2p+1}★h[m] (24)

where \check{d} is the data array obtained by inserting a zero between each two samples in d, and the symbol ★ is discrete convolution.

According to equation (23), the decomposition coefficient d_{J}^{p} of signal S at level J is following

d_{J}^{p}=dSₓ_{_{J}}^{p}+dN_{rf}_{_{J}}^{p}+dNₕ_{_{J}}^{p}+dN_{w}_{_{J}}^{p} (25)

where the coefficients d_{J}^{p} are the wavelet decomposition coefficients, whereas dSₓ_{_{J}}^{p}, dN_{rf}_{_{J}}^{p}, dNₕ_{_{J}}^{p}, and dN_{w}_{_{J}}^{p} are the transform coefficients of Sₓ, N_{rf}, Nₕ, and N_{w}. The d_{J}^{p} are considered by the signal S filtered by band-pass filter Ψ_{J}^{p} and subsampled by factor 2^{J}.

Transform coefficients ρᵢ′ are referred as the filtering result of the ρᵢ (RF interference induced by ith electrode) through the Ψ_{J}^{p}, therefore, the formula of dN_{rf}_{_{J}}^{p} can be expressed as

$$\begin{matrix}{dN}_{{rf}_{j}^{p}} ( {t}_{n} ) = {\sum }_{i = 1}^{l} {ρ}_{i}^{′} ( {t}_{n} ) \\ = {\sum }_{i = 1}^{l} {a}_{i}^{′} ( {t}_{n} ) sin ( 2 π {f}_{rf} {t}_{n} + {ϕ}_{i}^{′} )\end{matrix} \qquad ( 26 )$$

where aᵢ′ (tₙ) is a linear function which is proportional to the voltage scan of RF field, f_{rf} is the driving frequency of rf, φᵢ′ is the initial phase of ρᵢ′, and tₙ is discrete time at sample n which is written as

$${t}_{n} = \frac{{2}^{J} n}{{f}_{s}} \qquad ( 27 )$$

where fₛ is the sampling rate which is set as

fₛ=2^{J}·f_{rf} (28)

Inserting equations (28) and (27) into equation (26) which leads to

$$\begin{matrix}{dN}_{{rf}_{J}^{p}} [ n ] = {\sum }_{i = 1}^{l} {a}_{i}^{′} ( n / {f}_{rf} ) sin ( 2 π n + {ϕ}_{i}^{′} ) \\ = {\sum }_{i = 1}^{l} {a}_{i}^{′} ( n / {f}_{rf} ) sin ( {ϕ}_{i}^{′} ) \\ = α ( n / {f}_{rf} )\end{matrix} \qquad ( 29 )$$

where α is a linear function of scan time.

In equation (29), the dN_{rf}_{_{J}}^{p} is a non-horizontal linear baseline α(n/f_{rf}) in wavelet packet decomposition coefficient d_{J}^{p}. Here, we demonstrate a real signal and its wavelet packet decomposition coefficients in FIG. 10 and FIG. 10a shows the raw signal produced by a test pulse. The RF voltage scan condition is set at frequency of 14 kHz and amplitude is scanned from 18 to 90 Volts. FIGS. 10b-i are the wavelet packet decomposition coefficients of FIG. 10a at the deepest level J=3 by Haar wavelet.²⁰ FIG. 10b shows the approximate coefficient d₃⁰ which is consisted of S only via the low pass filter g[n] for 3 times. FIGS. 10c-i are the detail coefficients in 1^{st} to 7^{th} frequency sub-band. High order frequency sub-band denotes the detail coefficient of high frequency components in FIG. 10a. To cancel the RF interference, we shift the non-horizontal linear baseline b_{J}^{p} in d_{J}^{p} back to zero. Then a new decomposition coefficient d′_{J}^{p} by d′_{J}^{p}=d_{J}^{p}−b_{J}^{p} constructed. Finally, the signal without RF interference is reconstructed by d′_{J}^{p} using equation (24) until level j=0.

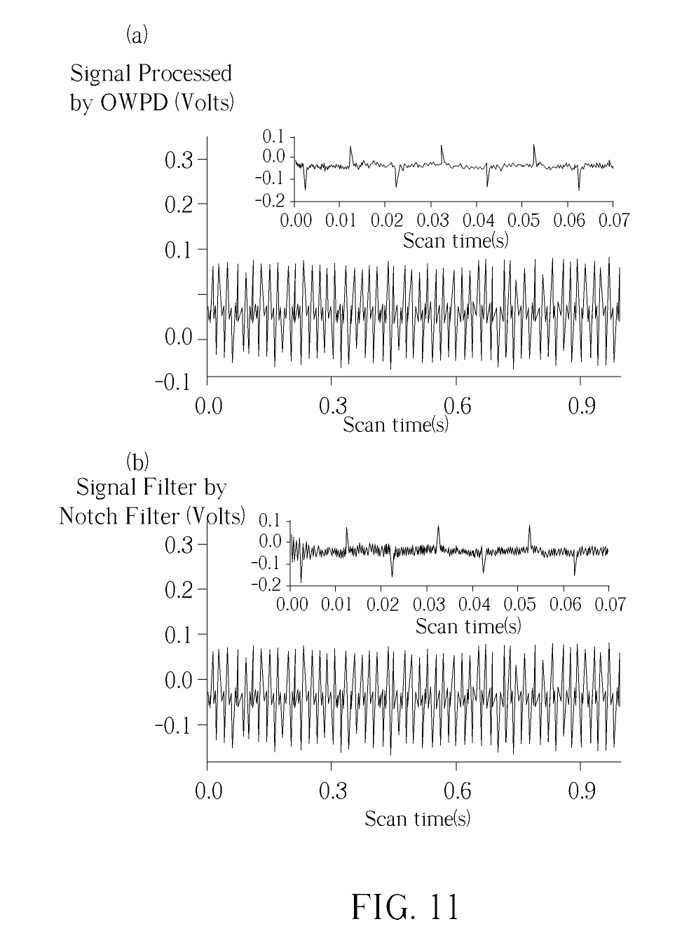

The signal processing result by OWPD method is shown in FIG. 11a, where the signal processing result by band-stop filter is shown in FIG. 11b. We found the OWPD method can remove RF interference completely, however, band-stop filter cannot remove it. This is because Fourier transform of RF interference with finite length signal (windowed by scan period) is not only a Dirac function but a convolution result of a Dirac function and a sinc function in frequency domain.²⁹

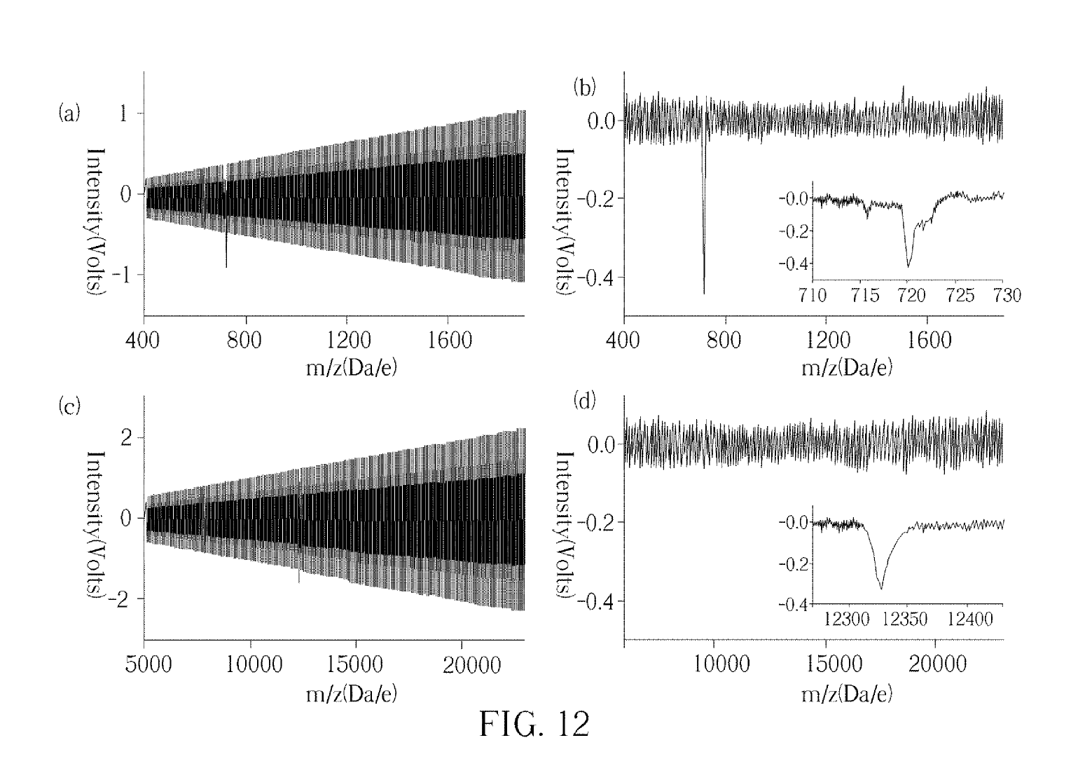

FIG. 12a and FIG. 12c show the raw mass spectra of C₆₀ and cytochrome C using CD-RIT mass spectrometer. FIG. 12b and FIG. 12d are the mass spectra of FIG. 12a and FIG. 12c without RF interference. It is clearly observed that the true signal is buried in the FIG. 12a and FIG. 12c with the cavity case only. However, with the help of OWPD technique, all induced RF interferences can be completely removed.

### CONCLUSIONS

We have developed for the first time by coupling charge detector with rectilinear ion trap mass spectrometer to detect high mass ions. Two key technologies, i.e. waveguide cavity is built to reduce the induced RF interference from RIT and OWPD based algorithm is developed to completely remove the RF interference without any signal distortion. The current CD-RIT MS technology can help develop LIT and LIT-hybrid instruments to detect high mass ions in the future.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal denoising method for a frequency-scan ion trap mass spectrometer, the method comprising:
reading a signal raw data array observed in the spectrometer;
processing the signal raw data array by Boxcar averaging method to obtain a first signal array;
processing the first signal array by a harmonic interference cancellation method to obtain a second data array;
processing the second signal array by a radio frequency (RF) interference reduction method; and
reconstructing a third signal array without background induced from driving voltage of ion trap according to the second signal array.

2. The method of claim 1, wherein the RF interference reduction method comprises:
step 202: reading a raw signal in time domain and reading hopping frequencies;
step 204: predicting ideal waveform of frequency scanned by the hopping frequencies;
step 206: calculating phase differences between the raw signal and the ideal waveform at each hopping frequencies;
step 208: calculating true phases at each sampling points of the raw signal;
step 210: inputting a number i of phases N for resampling, beginning with i=0;
step 212: resampling the raw signal at phase[i]=2*pi*i/N, wherein pi is the ratio of a circle's circumference to its diameter;
step 214: determining the baseline[i] of resampled signals by using wavelet decomposition and reconstruction;
step 216: checking if i is equal to N; if so, i=i+1 and go to step 212; if not, go to step 218;
step 218: finding an amplitude A by fitting baseline[i] with a function A*sin(phase[i]);
step 220: constructing background at each sampling points by a function A*sin(true phases);
step 222: subtracting the background from the raw signal; and
step 224: outputting a signal without the background induced from driving voltage of ion trap.

3. The method of claim 1 further comprising:
reading driving voltage waveform;
reading trapping frequency;
reading final frequency;
reading sampling rate of driving voltage waveform;
reading duration of frequency scan; and
reading step of frequency scan.

4. An RF interference cancellation method for a frequency-scan ion trap mass spectrometer, the method comprising:
step 402: reading a raw signal in time domain and reading hopping frequencies;
step 404: predicting ideal waveform of frequency scanned by the hopping frequencies;
step 406: calculating phase differences between the raw signal and the ideal waveform at each hopping frequencies;
step 408: calculating true phases at each sampling points of the raw signal;
step 410: inputting a number i of phases N for resampling, beginning with i=0;
step 412: resampling the raw signal at phase[i]=2*pi*i/N, wherein pi is the ratio of a circle's circumference to its diameter;
step 414: determining the baseline[i] of resampled signals by using wavelet decomposition and reconstruction;
step 416: checking if i is equal to N; if not, i=i+1 and go to step 412; if so, go to step 418;
step 418: finding an amplitude A by fitting baseline[i] with a function A*sin(phase[i]);
step 420: constructing background at each sampling points by a function A*sin(true phases);
step 422: subtracting the background from the raw signal; and
step 424: outputting signal without background induced from driving voltage of ion trap.

5. An RF interference cancellation method for a charge detection voltage-scan rectilinear/linear ion trap mass spectrometer comprising:
combining a charge detector and rectilinear/linear ion trap for detecting high mass ions;
providing a waveguide cavity surrounding the rectilinear/linear ion trap to reduce induced radio frequency interference from the rectilinear/linear ion trap;
utilizing an orthogonal wavelet packet decomposition (OWPD) based algorithm to remove radio frequency interference substantially without any signal distortion;
step 602: reading a signal S in time domain and reading an input driving frequency f;
step 604: resampling the signal S with a sampling rate f*2̂J, wherein J is a deepest decomposition level;
step 606: decomposing the signal S by wavelet packet decomposition to level J, wherein the wavelet packet decomposition coefficients are D₀, D₁ . . . D_{2J-1};
step 608: setting a number i=1;
step 610: fitting D with a liner function and subtracting the linear function from Dᵢ;
step 612: setting i=i+1;
step 614: checking if i is equal to 2J−1; if not, go to step 610; if so, go to step 616;
step 616: getting a denoised signal from reconstruction of the wavelet packet decomposition coefficients; and
step 618: writing the denoised signal.

6. The method of claim 5, wherein the signal S and the input frequency f are read at electrodes of the voltage-scan ion trap mass spectrometer.
